(19) United States
(12) Patent Application Publication
(10) Pub. No.: US 2014/0130037 A1
(43) Pub. Date: May 8, 2014

(54) COMPUTER APPLICATION PLAYLIST AND PLAYER

(71) Applicant: Gigaspaces Technologies Ltd., Herzliya (IL)

(72) Inventor: NATI SHALOM, HERZLIYA (IL)

(21) Appl. No.: 14/073,962

(22) Filed: Nov. 7, 2013

Related U.S. Application Data
(60) Provisional application No. 61/723,796, filed on Nov. 8, 2012.

(51) Int. Cl. G06F 9/445

(52) U.S. Cl. CPC G06F 8/61
USPC 717/176

(57) ABSTRACT

Facilitating the installation and configuration of computer application resources by providing an application player that is embeddable into a web page, receiving a request from the application player, where the request includes information sufficient to identify a recipe for installing and configuring a predefined set of application resources associated with one or more computer-based applications, identifying the recipe using the information from the request, installing and configuring the predefined set of application resources in accordance with the recipe, where the application resources are installed into one or more computing environments, and providing to the application player a hyperlink that is configured to facilitate access to any of the application resources in any of the computing environments.

### CROSS-REFERENCE TO RELATED APPLICATIONS

This application claims the benefit of priority from U.S. Provisional Patent Application No. 61/723,796, filed Nov. 8, 2012, the contents of which are incorporated by reference in their entirety.

### FIELD OF THE INVENTION

The invention relates to computing in general, and more particularly to systems and methods for installing and configuring complex, cooperative, multi-application computing environments.

### BACKGROUND OF THE INVENTION

Information technology managers often face the difficult task of evaluating computer applications and resources to determine what computer applications and resources should be employed by their organizations and how best to configure and deploy them. Unfortunately, much time and effort is spent installing and configuring candidate applications and resources just for the purpose of performing such evaluations. Individual vendors of the different computer applications and resources may provide “plain vanilla” versions of their products for evaluation purposes that are pre-installed in computer environments that are specially designated for testing purposes. However, this approach often does not suit organizations where managers must evaluate different computer applications and resources for their ability to operate in a coordinated manner, as well as to operate in various computing environments and under various conditions.

### SUMMARY OF THE INVENTION

In one aspect of the invention a method is provided for facilitating the installation and configuration of computer application resources, the method including providing an application player that is embeddable into a web page, receiving a request from the application player, where the request includes information sufficient to identify a recipe for installing and configuring a predefined set of application resources associated with one or more computer-based applications, identifying the recipe using the information from the request, installing and configuring the predefined set of application resources in accordance with the recipe, where the application resources are installed into one or more computing environments, and providing to the application player a hyperlink that is configured to facilitate access to any of the application resources in any of the computing environments.

In another aspect of the invention the method further includes providing a list of one or more application profiles for presentation in association with the application player, where each of the application profiles is associated with a different recipe for installing and configuring application resources associated with one or more computer-based applications.

In another aspect of the invention the method further includes configuring the application player to send the request responsive to a selection of any of the application profiles, where the recipe identified by the request is associated with the selected application profile.

In another aspect of the invention the method further includes configuring the application player to send the request responsive to an interaction with an interface element of the application player.

In another aspect of the invention the method further includes configuring the application player to accept input of credentials, where any of the computer-based applications, application resources, and computing environments are made available for the installing and configuring using the credentials.

In another aspect of the invention the installing and configuring are performed using a temporary account where any of the computer-based applications and application resources associated with the computer-based applications indicated in the recipe are automatically terminated after a predefined amount of time has elapsed after the installing and configuring are performed.

In another aspect of the invention the method further includes configuring the application player to record information regarding user interactions with any of the web page, the application player, and application profiles, and report on the interactions to a computer server.

In another aspect of the invention the method further includes implementing the providing, receiving, identifying, installing, and configuring steps in any of a) computer hardware, and b) computer software embodied in a non-transitory, computer-readable storage medium.

In another aspect of the invention a system is provided for facilitating the installation and configuration of computer application resources, the system including an application player that is embeddable into a web page, where the application player is configured to send a request identifying a recipe for installing and configuring a predefined set of application resources associated with one or more computer-based applications, and a computer server configured to receive the request, install and configure the predefined set of application resources in accordance with the recipe, where the application resources are installed into one or more computing environments, and provide to the application player a hyperlink that is configured to facilitate access to any of the application resources in any of the computing environments.

In another aspect of the invention the system further includes a list of one or more application profiles for presentation in association with the application player, where each of the application profiles is associated with a different recipe for installing and configuring application resources associated with one or more computer-based applications.

In another aspect of the invention the application player is configured to send the request responsive to a selection of any of the application profiles, where the recipe identified by the request is associated with the selected application profile.

In another aspect of the invention the application player is configured to send the request responsive to an interaction with an interface element of the application player.

In another aspect of the invention the application player is configured to accept input of credentials, where any of the computer-based applications, application resources, and computing environments are made available for installation and configuration using the credentials.

In another aspect of the invention installation and configuration of any of the computer-based applications, application resources, and computing environments are performed using a temporary account where any of the computer-based applications and application resources associated with the computer-based applications indicated in the recipe are automatically terminated after a predefined amount of time has elapsed after the installing and configuring are performed.

In another aspect of the invention the application player is configured to record information regarding user interactions with any of the web page, the application player, and application profiles, and report on the interactions to the computer server.

In another aspect of the invention the system further includes implementing the application player in any of a) computer hardware, and b) computer software embodied in a non-transitory, computer-readable storage medium.

In another aspect of the invention a method is provided for facilitating the installation and configuration of computer application resources, the method including receiving a selection of an application profile at an application player that is embedded into a web page, and sending a request to a computer server, where the request includes information sufficient to identify a recipe for installing and configuring a predefined set of application resources associated with one or more computer-based applications, and where the computer server is configured to identify the recipe using the information from the request, install and configure the predefined set of application resources in accordance with the recipe, where the application resources are installed into one or more computing environments, and provide to the application player a hyperlink that is configured to facilitate access to any of the application resources in any of the computing environments.

### BRIEF DESCRIPTION OF THE DRAWINGS

The invention will be understood and appreciated more fully from the following detailed description taken in conjunction with the appended drawings in which:

FIG. 1A is a simplified conceptual illustration of a computer application player system, constructed and operative in accordance with an embodiment of the invention;

FIG. 1B illustrates selected elements of FIG. 1A;

FIG. 2 is a simplified flowchart illustration of an exemplary method of operation of the system of FIG. 1A, operative in accordance with an embodiment of the invention; and

FIG. 3 is a simplified block diagram illustration of an exemplary hardware implementation of a computing system, constructed and operative in accordance with an embodiment of the invention.

### DETAILED DESCRIPTION OF THE INVENTION

The invention is now described within the context of one or more embodiments, although the description is intended to be illustrative of the invention as a whole, and is not to be construed as limiting the invention to the embodiments shown. It is appreciated that various modifications may occur to those skilled in the art that, while not specifically shown herein, are nevertheless within the true spirit and scope of the invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical data storage device, a magnetic data storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java™, Smalltalk™, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

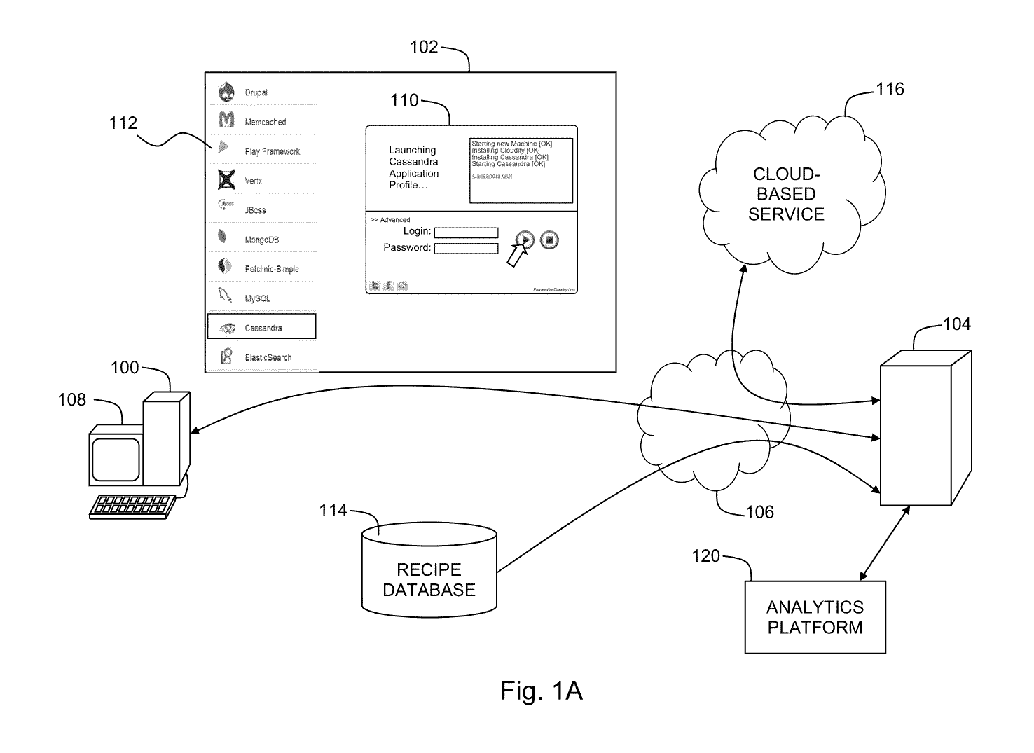

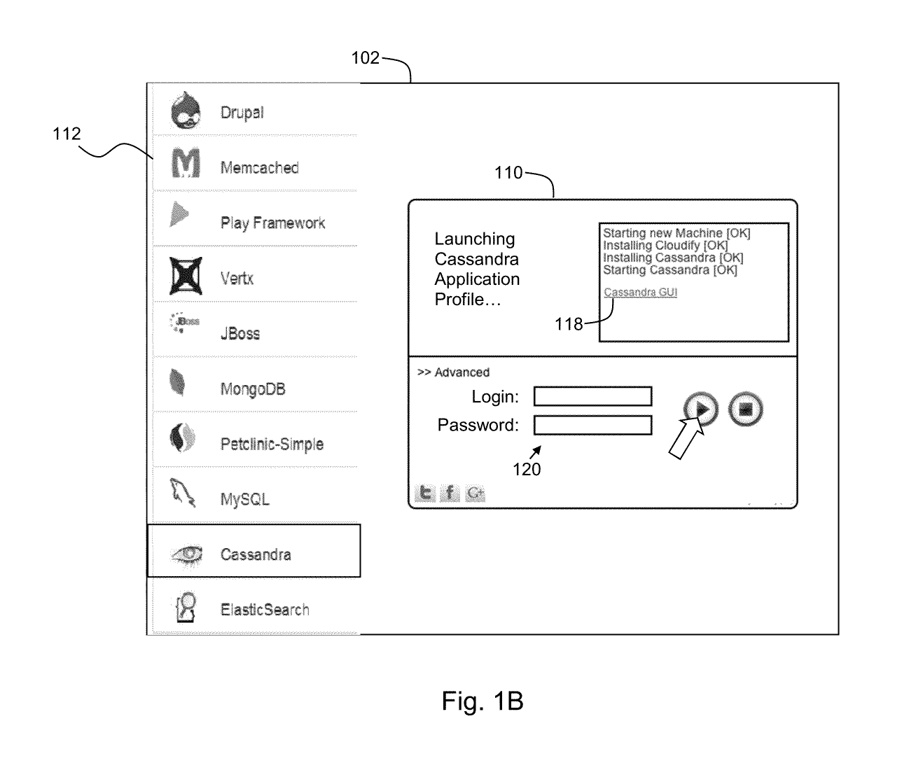

Reference is now made to FIG. 1A, which is a simplified conceptual illustration of a computer application player system, constructed and operative in accordance with an embodiment of the invention. In the system of FIG. 1A, a computer 100 is shown retrieving a web page 102 from a computer server 104 via a computer network 106, such as the Internet. Web page 102 is rendered and displayed at computer 100 in accordance with conventional techniques, such as by using a browser which renders and displays web page 102 on a computer monitor 108. Web page 102 includes an embedded application player 110 that is preferably displayed within web page 102. Also preferably displayed within web page 102 is a list of one or more application profiles 112, where each application profile 112 is associated with a predefined set or “recipe” of installation and/or configuration instructions, such as may be stored in a database 114 of recipes in accordance with conventional techniques. Web page 102, application player 110, and application profiles 112 are shown enlarged in FIG. 1B. Each recipe in database 114 may, for example, be configured for use with Cloudify™, commercially-available from GigaSpaces Technologies Inc., New York, N.Y. Application player 110 is preferably configured such that a user selection of a particular application profile 112, such as by “clicking” on a particular application profile 112 within web page 102 using a pointing device, causes application player 110 to send a request to a computer server, such as computer server 104, to perform the instructions in the selected recipe, where server 104 is configured to fulfill such requests, such as in accordance with Cloudify™ procedures. Application player 110 may send the request directly in response to the user selection of a particular application profile 112, or may be configured to do so in response to an interaction with an interface element of application player 110, such as after a play button that is displayed within application player 110 is pressed. Application player 110 may send the selected recipe to server 104 or, alternatively, application player 110 may provide to server 104 sufficient information identifying the selected recipe so as to enable server 104 to access the selected recipe, such as from database 114.

In an alternative embodiment application player 110 is preconfigured in association with a particular application profile 112, such that a user selection of the preconfigured application profile 112 is not required, where instead application player 110 sends the request to server 104 when a play button that is displayed within application player 110 is pressed. In this configuration application player 110 may be embedded within any web page without displaying a list of application profiles 112 as described above.

After receiving a request from application player 110 to perform the instructions in a particular recipe, server 104 performs the instructions in accordance with conventional techniques, such as by installing and/or configuring a predefined set of one or more computer-based applications and application resources associated with the computer-based applications as indicated in the recipe. Server 104 installs and/or configures the applications and related resources in accordance with the recipe into one or more computing environments and utilizing various types of computer resources, such as by utilizing one or more computers, virtual machines (VMs), data storage devices, or any combination thereof, that may be managed by one or more cloud-based services 116, such as Amazon Elastic Compute Cloud (Amazon EC2), commercially-available from Amazon Web Services, Inc., Seattle, Wash.

After performing the instructions in a particular recipe in response to a request by application player 110 to do so, server 104 preferably provides application player 110 with one or more hyperlinks configured to facilitate access to any of the computer-based applications and application resources associated with the computer-based applications as indicated in the recipe. For example, where the recipe includes instructions to install Cassandra™, commercially-available from the Apache Software Foundation, Forest Hill, Md., server 104 preferably provides application player 110 with a hyperlink 118 (FIG. 1B) to the Cassandra™ manager on the computer or VM where Cassandra™ is installed, which hyperlink is preferably displayed within application player 110.

In an alternative embodiment application player 110 is configured to accept input of credentials 120 (FIG. 1B) in accordance with conventional techniques, such as from a computer user who is interacting with web page 102 and application player 110. The credentials may, for example, be a user name and password of an account belonging to cloud-based service 116. In this configuration application player 110 preferably provides the credentials to server 104, which then installs and/or configures the applications and related resources in accordance with the recipe using any resources that are made available to the account by cloud-based service 116. Additionally or alternatively, application player 110 is configured to install and/or configure the applications and related resources in accordance with the recipe using a guest account of cloud-based service 116 that provides, for a predefined amount of time, such as one hour, temporary use of the computer-based applications and application resources associated with the computer-based applications as indicated in the recipe, after which time the applications and related resources are automatically terminated and/or uninstalled.

In an alternative embodiment application player 110 is configured to record information regarding user interactions with web page 102, application player 110, and application profiles 112, and report on such interactions to server 104. Such information may, for example, indicate the frequency with which various application profiles 112 are selected, the amount of time a user spends using the applications and related resources of an installed application profile, and what actions users perform after interacting with the applications and related resources of an installed application profile. This information, as well as information regarding the nature and location of the applications and related resources of installed application profiles, may be viewed using an analytics platform 120, such as MixPanel™, commercially-available from Mixpanel, Inc., Mountain View, Calif.

Any of the elements shown in FIG. 1A are preferably implemented in computer hardware, and/or in computer software embodied in a non-transitory, computer-readable storage medium, in accordance with conventional techniques.

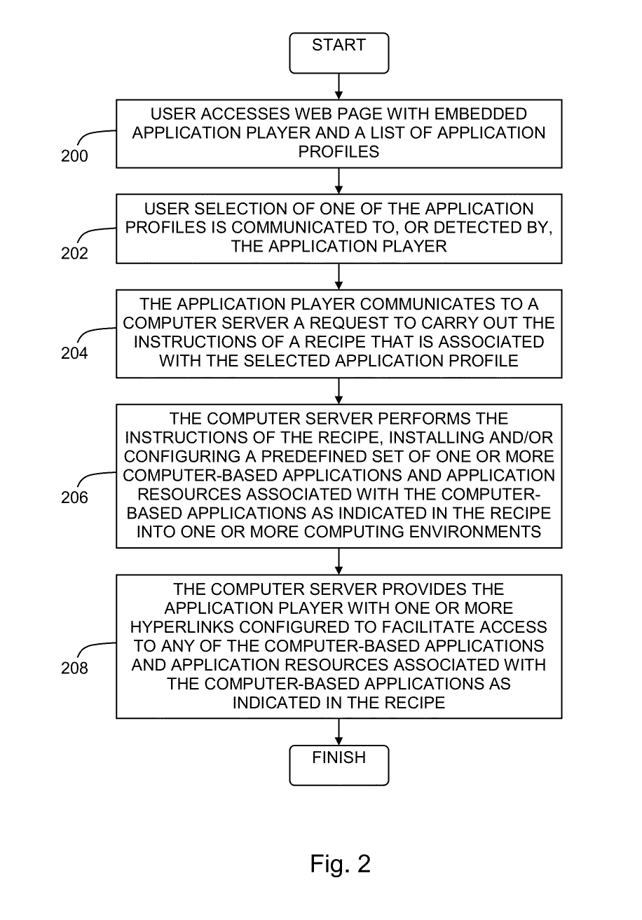

Reference is now made to FIG. 2, which is a simplified flowchart illustration of an exemplary method of operation of the system of FIG. 1A, operative in accordance with an embodiment of the invention. In the method of FIG. 2, a web page with an embedded application player and a list of application profiles is rendered and displayed at a computer (step 200). A user selection of one of the application profiles is communicated to, or detected by, the application player (step 202). The application player communicates to a computer server a request to carry out the instructions of a recipe that is associated with the selected application profile (step 204), such as in response to a user pressing a play button displayed within the application player. The computer server performs the instructions by installing and/or configuring a predefined set of one or more computer-based applications and application resources associated with the computer-based applications as indicated in the recipe into one or more computing environments (step 206). The computer server provides the application player with one or more hyperlinks configured to facilitate access to any of the computer-based applications and application resources associated with the computer-based applications as indicated in the recipe (step 208), which hyperlinks are preferably displayed within the application player.

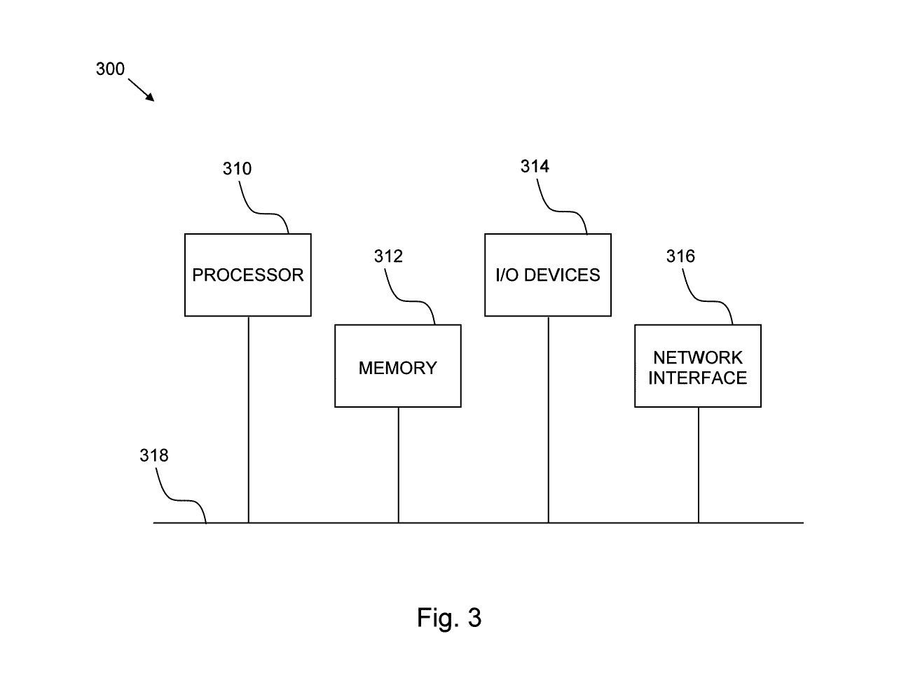

Referring now to FIG. 3, block diagram 300 illustrates an exemplary hardware implementation of a computing system in accordance with which one or more components/methodologies of the invention (e.g., components/methodologies described in the context of FIGS. 1A-2) may be implemented, according to an embodiment of the invention.

As shown, the techniques for controlling access to at least one resource may be implemented in accordance with a processor 310, a memory 312, I/O devices 314, and a network interface 316, coupled via a computer bus 318 or alternate connection arrangement.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

The flowchart and block diagrams in the Figures illustrate the architecture, functionality, and operation of possible implementations of systems, methods and computer program products according to various embodiments of the invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be appreciated that any of the elements described hereinabove may be implemented as a computer program product embodied in a computer-readable medium, such as in the form of computer program instructions stored on magnetic or optical storage media or embedded within computer hardware, and may be executed by or otherwise accessible to a computer.

While the methods and apparatus herein may or may not have been described with reference to specific computer hardware or software, it is appreciated that the methods and apparatus described herein may be readily implemented in computer hardware or software using conventional techniques.

While the invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A method for facilitating the installation and configuration of computer application resources, the method comprising:
providing an application player that is embeddable into a web page;
receiving a request from the application player, wherein the request includes information sufficient to identify a recipe for installing and configuring a predefined set of application resources associated with one or more computer-based applications;
identifying the recipe using the information from the request;
installing and configuring the predefined set of application resources in accordance with the recipe, wherein the application resources are installed into one or more computing environments; and
providing to the application player a hyperlink that is configured to facilitate access to any of the application resources in any of the computing environments.

2. The method according to claim 1 and further comprising providing a list of one or more application profiles for presentation in association with the application player, wherein each of the application profiles is associated with a different recipe for installing and configuring application resources associated with one or more computer-based applications.

3. The method according to claim 2 and further comprising configuring the application player to send the request responsive to a selection of any of the application profiles, wherein the recipe identified by the request is associated with the selected application profile.

4. The method according to claim 1 and further comprising configuring the application player to send the request responsive to an interaction with an interface element of the application player.

5. The method according to claim 1 and further comprising configuring the application player to accept input of credentials, wherein any of the computer-based applications, application resources, and computing environments are made available for the installing and configuring using the credentials.

6. The method according to claim 1 wherein the installing and configuring are performed using a temporary account wherein any of the computer-based applications and application resources associated with the computer-based applications indicated in the recipe are automatically terminated after a predefined amount of time has elapsed after the installing and configuring are performed.

7. The method according to claim 1 and further comprising configuring the application player to record information regarding user interactions with any of the web page, the application player, and application profiles, and report on the interactions to a computer server.

8. The method according to claim 1 and further comprising implementing the providing, receiving, identifying, installing, and configuring steps in any of
a) computer hardware, and
b) computer software embodied in a non-transitory, computer-readable storage medium.

9. A system for facilitating the installation and configuration of computer application resources, the system comprising:
an application player that is embeddable into a web page, wherein the application player is configured to send a request identifying a recipe for installing and configuring a predefined set of application resources associated with one or more computer-based applications; and
a computer server configured to
receive the request,
install and configure the predefined set of application resources in accordance with the recipe, wherein the application resources are installed into one or more computing environments, and
provide to the application player a hyperlink that is configured to facilitate access to any of the application resources in any of the computing environments.

10. The system according to claim 9 and further comprising a list of one or more application profiles for presentation in association with the application player, wherein each of the application profiles is associated with a different recipe for installing and configuring application resources associated with one or more computer-based applications.

11. The system according to claim 10 wherein the application player is configured to send the request responsive to a selection of any of the application profiles, wherein the recipe identified by the request is associated with the selected application profile.

12. The system according to claim 9 wherein the application player is configured to send the request responsive to an interaction with an interface element of the application player.

13. The system according to claim 9 wherein the application player is configured to accept input of credentials, wherein any of the computer-based applications, application resources, and computing environments are made available for installation and configuration using the credentials.

14. The system according to claim 9 wherein installation and configuration of any of the computer-based applications, application resources, and computing environments are performed using a temporary account wherein any of the computer-based applications and application resources associated with the computer-based applications indicated in the recipe are automatically terminated after a predefined amount of time has elapsed after the installing and configuring are performed.

15. The system according to claim 9 wherein the application player is configured to record information regarding user interactions with any of the web page, the application player, and application profiles, and report on the interactions to the computer server.

16. The system according to claim 9 and further comprising implementing the application player in any of
a) computer hardware, and
b) computer software embodied in a non-transitory, computer-readable storage medium.

17. A method for facilitating the installation and configuration of computer application resources, the method comprising:
receiving a selection of an application profile at an application player that is embedded into a web page; and
sending a request to a computer server, wherein the request includes information sufficient to identify a recipe for installing and configuring a predefined set of application resources associated with one or more computer-based applications, and wherein the computer server is configured to
identify the recipe using the information from the request,
install and configure the predefined set of application resources in accordance with the recipe, wherein the application resources are installed into one or more computing environments, and
provide to the application player a hyperlink that is configured to facilitate access to any of the application resources in any of the computing environments.

18. The method according to claim 17 and further comprising recording information regarding user interactions with any of the web page, the application player, and application profiles, and report on the interactions to a computer server.

19. The method according to claim 17 and further comprising implementing the receiving and sending steps in any of
a) computer hardware, and
b) computer software embodied in a non-transitory, computer-readable storage medium.
